(19) United States
(12) Patent Application Publication
(10) Pub. No.: US 2012/0013296 A1
(43) Pub. Date: Jan. 19, 2012

(54) METHOD AND SYSTEM FOR HARVESTING RF SIGNALS AND WIRELESSLY CHARGING A DEVICE

(76) Inventors: Soudeh Heydari, Dubai (AE); Mohammad Asefi, Dubai (AE)

(21) Appl. No.: 13/181,448

(22) Filed: Jul. 12, 2011

Related U.S. Application Data
(60) Provisional application No. 61/364,731, filed on Jul. 15, 2010.
(60) Provisional application No. 61/364,739, filed on Jul. 15, 2010.

(51) Int. Cl. H02J 7/00; H02J 17/00

(52) U.S. Cl. 320/108; 307/104

(57) ABSTRACT

System and method for harvesting radio frequency power from a wireless transmitter includes; an antenna having an output voltage, a matching network coupled to the antenna, a booster circuit coupled to the matching network and having an output voltage, and adapted to amplify the output voltage of the antenna. Matching network is adapted to match a power transfer. A voltage stabilizer circuit is adapted to stabilize the booster circuit output voltage. Method includes, determining at least one operating mode and charging a slave device from a master wireless transmitter located within a predetermined distance from the system. A rechargeable battery in the system is charged from a wireless transmitter, and a slave device is connected to the system. The slave device is charged from the rechargeable battery in the system.

### CROSS-REFERENCES TO RELATED APPLICATIONS

The present application claims benefit under 35 USC 119(e) of commonly assigned U.S. provisional application No. 61/364,731, filed Jul. 15, 2010, entitled “Method and System For Harvesting RF Signals and Wirelessly Charging A Device,” and U.S. provisional application No. 61/364,739, filed Jul. 15, 2010, entitled “Wireless Battery Charger,” the contents of all of which are incorporated herein by reference in their entirety.

### BACKGROUND

The present invention relates generally to supplying power to portable devices. More specifically, some embodiments of the present invention relate to harvesting radio frequency (RF) signals to power portable devices.

In the world of nanotechnology and wireless communication and networking, power supply of electrical devices still is a matter of concern. Many scientists and researchers are working on various methods of production, transmission and storing energy. Portable devices powered by rechargeable batteries commonly need chargers or base stations that are connected by wire from a power grid. Such portable devices include cell-phones, personal digital assistants, smart-phones, tablets, and remote controls, among others. Some of these devices rely on radio frequency signals for communication purposes.

The existing wireless chargers have operation distance limitations which prevents them from being used in locations without access to the wired power grid. This means that the device to be charged has to be in locations where a power outlet exists so that the charger can be connected to a power outlet and then the device to be charged must be placed on it (or kept within a short distance from it).

RF signals in the air have very limited power. Thus, the output power of an RF signal harvester is in the range of micro and milli-watts. Yet, various low power electronic devices can be empowered with this power.

### BRIEF SUMMARY

The present invention relates generally to supplying power to portable devices. More specifically, some embodiments of the present invention relate to harvesting radio frequency (RF) power to power portable devices.

According to one embodiment of the present invention, a system for harvesting radio frequency power from a wireless transmitter includes; (i) an antenna having an output voltage, (ii) a matching network coupled to the antenna, (iii) a booster circuit coupled to the matching network and having an output voltage, and adapted to amplify the output voltage of the antenna. The matching network is adapted to match a power transfer from the antenna to the booster circuit. The system for harvesting radio frequency power from the wireless transmitter further includes a voltage stabilizer circuit adapted to stabilize the output voltage of the booster circuit.

According to one specific embodiment, the system further includes a user selectable switch adapted to determine at least one operating mode, and a connector adapted to charge a slave device. At least one operating mode is adapted to charge the slave device from a master wireless transmitter located within a predetermined distance from the system.

According to another specific embodiment, the system further includes: (i) a user selectable switch adapted to determine at least one operating mode, (ii) a rechargeable battery adapted to be charged by the booster circuit, and (iii) a connector adapted to charge a slave device. The at least one operating mode is adapted to charge the rechargeable battery from a wireless transmitter located within a predetermined distance from the system and the rechargeable battery is adapted to charge the slave device.

According to another specific embodiment, the antenna is a wideband antenna. According to another specific embodiment, the antenna is a wideband circularly polarized micro-strip patch antenna.

According to another specific embodiment, the matching network is a resonant circuit tuned at a predetermined frequency. According to another specific embodiment, the booster circuit includes a multi-stage voltage multiplier circuit.

According to another specific embodiment, the system further includes a software executable on the master wireless transmitter and adapted to provide a user selectable amount of radio frequency power from the master wireless transmitter to the slave device.

According to another specific embodiment, the master wireless transmitter is adapted to transmit a user selectable file. The duration of the transmission corresponds to the amount of radio frequency power transmitted from the master wireless transmitter to the slave device.

According to another specific embodiment, the master wireless transmitter is chosen from one of the group of a cell-phone, a laptop, or a personal computer. According to another specific embodiment, the master wireless transmitter is adapted to transmit radio frequency power chosen from of one of the group of a Bluetooth signal, or a Wi-Fi signal.

According to another specific embodiment, the predetermined distance is about 1 meter. According to another specific embodiment, the predetermined distance is about 500 meters.

According to another specific embodiment, the wireless transmitter is adapted to transmit radio frequency power for the system. According to another specific embodiment, the wireless transmitter is adapted to transmit radio frequency power for the system in the form of one of the group of a GSM signal, or a Wi-Fi signal. According to another specific embodiment, the system is adapted to receive a signal having a power of at least −25 dBm.

According to one embodiment of the present invention, a method for harvesting radio frequency power from a wireless transmitter by a system including an antenna having an output voltage, a matching network coupled to the antenna, a booster circuit coupled to the matching network and having an output voltage, and a voltage stabilizer circuit, the method includes, matching a power transfer from the antenna to the booster circuit, amplifying the output voltage of the antenna, and stabilizing the output voltage of the booster circuit.

According to one specific embodiment, the method further includes determining at least one operating mode. According to another specific embodiment, the method further includes charging a slave device from a master wireless transmitter located within a predetermined distance from the system.

According to another specific embodiment, the method further includes charging a rechargeable battery in the system from a wireless transmitter located within a predetermined distance from the system, and connecting a slave device to the system. The slave device is charged from the rechargeable battery in the system.

A better understanding of the nature and advantages of the embodiments of the present invention may be gained with reference to the following detailed description and the accompanying drawings.

### BRIEF DESCRIPTION OF THE DRAWINGS

FIG. 1 is a simplified block diagram showing a system for harvesting radio frequency power from a wireless transmitter in accordance with an embodiment of the present invention;

FIG. 2 is a simplified schematic diagram showing a matching circuit in accordance with an embodiment of the present invention;

FIG. 3 is a simplified schematic diagram showing a booster circuit in accordance with a first embodiment of the present invention;

FIG. 4 is an example of an output voltage response with respect to input RF power for the embodiment shown in FIG. 1;

FIG. 5 is a simplified schematic diagram showing a booster circuit in accordance with a second embodiment of the present invention;

FIG. 6 is a simplified block diagram showing a method for harvesting radio frequency power from a wireless transmitter in accordance with an embodiment of the present invention;

### DETAILED DESCRIPTION

According to the embodiments of the present invention, a system and method for harvesting radio frequency power from a wireless transmitter are described. The system may include a wireless charger that reuses the wasted power of RF signals in the environment. Although the output power of an RF signal harvester is in the range of micro and milli-watts, various low power electronic devices can be empowered with this low power. Some examples of such low power electronic devices may include: calculators, wireless chargers, low power electric devices (sensors, Remote Telemetry Units (RTUs) and the like), low power home appliances (remote controls, watches and the like), biomedical applications (empowering artificial organs such as implanted hearts), and robotics (robotic cells). In such applications, the RF signal harvester can replace batteries. In some applications, a high power transmitter may be placed in the field to provide the RF signals for the RF signal harvester. Using this system, one can charge up his/her portable device enough for a short operation time. For instance, if a cell-phone is to be charged, using the proposed method, the cell-phone will have enough battery power for a few calls.

Table 1 shows a comparison between an existing RF signal harvester and an RF signal harvester in accordance with embodiments of the present invention. Both of the harvesters were tested under the same conditions (i.e. normal movement, outdoor, and indoor environments). The approximated price of the prototype may be reduced by mass production.

TABLE 1

| | | Output | | |
|---|---|---|---|---|
| | Size | Voltage | Cost | Special |
| Harvester | (cm) | (mV) | ($) | considerations |
| Commercialized | 4 × 7.5 | 0.25-0.4 | 100 | Voltage is based on |
| Piezoelectric | | | | tested measurements |
| Proposed RF | 2 × 3.5 | 0.15-0.5 | 11.90 | Cost is approximated |
| Signal Harvester | | | | based on prototype |
| (prototype) | | | | assembly components |

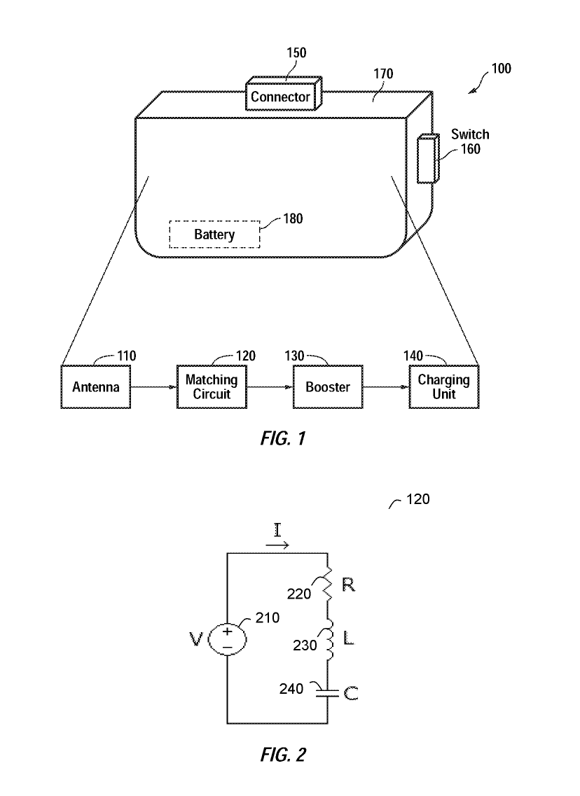

FIG. 1 is a simplified block diagram showing a system 100 for harvesting radio frequency power from a wireless transmitter in accordance with an embodiment of the present invention. System 100 may include an antenna 110, a matching circuit 120, a booster circuit 130 a charging unit 140, a connector 150, a switch 160, and a housing 170. Matching circuit 120 is coupled between antenna 110 and booster circuit 130. Booster circuit 130 is coupled to charging unit 140. The antenna 110, matching circuit 120, booster circuit 130, and charging unit 140 may be contained in housing 170, which may support connector 150 and switch 160. Alternatively, antenna 110, matching circuit 120, booster circuit 130, and charging unit 140 may be embedded in a low power wireless device. Connector 150 may include either a custom designed connector for each low power electronic device application or may include a general plug and a set of adaptor connectors to couple each low power electronic device application with the general plug. Switch may be user selectable and adapted to determine at least one operating mode to be described below. In one operating mode system 100 may further include an optional rechargeable battery 180, which is coupled to charging unit 140 in housing 170. In each operating mode, the switch either couples charging unit 140 to battery 180 and battery 180 to connector 150, or couples charging unit 140 directly to connector 150.

Antenna 110 may be a wideband circularly polarized micro-strip patch antenna. The polarization is selected to be circular so that the antenna can receive signals of all polarizations. Moreover, the antenna is wideband so that a wider range of signals can be harvested. Antenna 110 has an output voltage coupled to matching circuit 120.

FIG. 2 is a simplified schematic diagram showing matching circuit 120 in accordance with an embodiment of the present invention. Matching circuit 120 may be tuned at a predetermined frequency, which, depending on the system of wireless communication, can be a Bluetooth frequency of 2.4 GHz or 5 GHz, or a GSM signal of frequencies from 900 MHz to 2 GHz) so that the mismatch losses are reduced and maximum power is delivered to booster circuit 130. Matching circuit 120 may include a resonant circuit, which can help reduce noise and interference to other operating wireless systems. This noise and interference reduction is achieved by minimization of the reflected back signals due to mismatch. The matching circuit 120 may include a series RLC circuit 220, 230, 240 respectively. The design of matching circuit 120 is frequency dependent and may be designed in a way that power transfer losses are minimized.

Booster circuit 130 may either include diodes and capacitors or MOSFET transistors and capacitors to boost the output voltage of antenna 110 to voltage levels acceptable for charging a low power electronic device or battery 180. FIG. 3 is a simplified schematic diagram showing a booster circuit 130a in accordance with a first embodiment of the present invention, which includes a multi-stage voltage multiplier circuit such as, for example, a six stage voltage multiplier circuit designed with capacitors 301-306 and schottky diodes 311-316. Booster circuit 130a is designed in a way that changes in the value of capacitors does not affect the output of the booster significantly. In one example, capacitors 301-306 are each 1 pF.

In booster circuit 130a, the RF signal wave is rectified at its negative half of the cycle by C301 and D311, and in its positive half by C303 and D312. During the positive half-cycle, the voltage stored in C301 from the negative half-cycle is transferred to C303, which causes the voltage of C303 to be roughly two times the peak voltage of the RF source and is why this 2-stage portion of booster circuit 130a may be called a voltage doubler. The doubled voltage level is minus the turn-on voltage of the diode. Each stage of voltage multiplier contains one diode and one capacitor and operates in the manner described above. The number of stages determines the amount of multiplication (alternatively referred to herein as “amplification”).

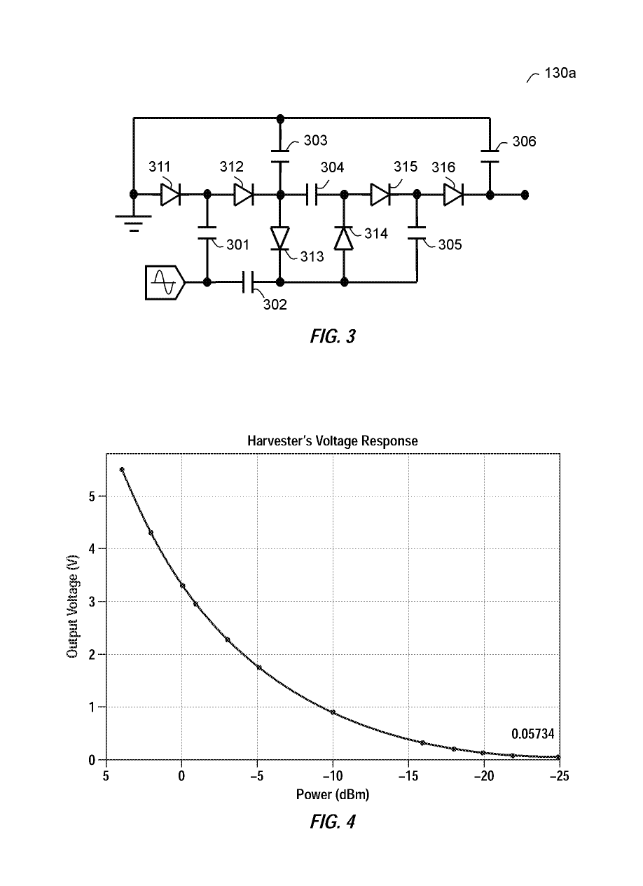

FIG. 4 is an example of an output voltage response with respect to input RF power for the embodiment shown in FIG. 1. The power of Bluetooth signals may not exceed 0 dBm so the higher powers are provided for lab measurement purposes. As can be observed from FIG. 4, a voltage of 3 volts can be achieved using a Bluetooth signal to charge a battery or a low power device. As long as a potential deference across the battery is maintained, the current will flow through it, resulting in charging.

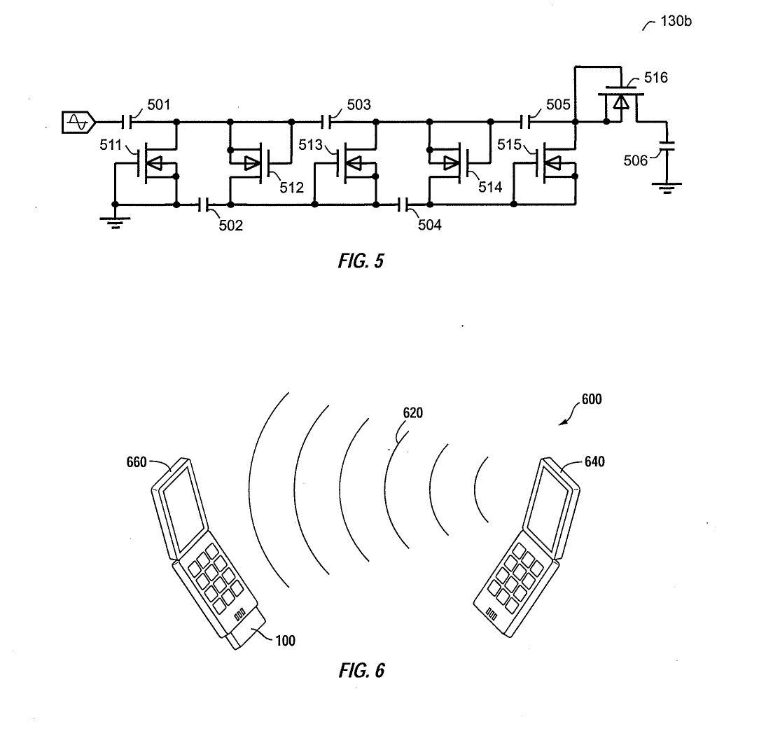

The booster circuit, which is a voltage multiplier, is used to amplify the output voltage of the antenna. Yet, the current gets reduced since the electric power follows the law of conservation of energy. Thus, the booster or the voltage amplifier may be designed in such a way that the power loss through the booster circuit is minimized. To achieve this goal, the booster circuit may include MOSFET transistors. FIG. 5 is a simplified schematic diagram showing a booster circuit 130b, in accordance with a second embodiment of the present invention, which includes a multi-stage voltage multiplier circuit such as, for example, a six stage voltage multiplier circuit designed with capacitors 501-506 and n-channel MOSFET transistors 511-516. In this example, NMOS transistors are used, however, other types of transistors such as PMOS, and different combinations of PMOS and NMOS transistors may also be used.

Booster circuit 130b works on the same basic principles as booster circuit 130a. Booster circuit 130b is similar to, but not exactly the same as, booster circuit 130a. The difference with booster circuit 130b is that the output is more stabilized compared to booster circuit 130b since the turn-on voltage of the MOSFETs in booster circuit 130b is smaller than the turn-on voltage of the diodes included in booster circuit 130a. Thus, each multiplier stage in booster circuit 130b “pumps” current with less voltage loss resulting in better circuit power efficiency and the device technology may use standard CMOS technology, without requiring schottky diodes as in booster circuit 130a.

The output signal of booster circuit 130 is a DC signal, which can be used to charge a battery or empower a circuit. However, this DC signal should be stabilized. Thus, a charger unit may include a voltage stabilizer, usually a voltage regulator circuit, and an input-output port to interface between system 100 and the low power device to be charged. Currently, the size of the prototype is 5 cm by 0.4021 cm, which may be further reduced for production.

System 100 may include two different modes of operation in accordance with an embodiment of the present invention. FIG. 6 is a simplified block diagram showing a method 600 for harvesting a radio frequency power 620 from a master wireless transmitter 640 in accordance with an embodiment of the present invention, by using a first mode to charge a slave device 660 with system 100 coupled to slave device 660. Master wireless transmitter 640 may include a device with wireless communication capabilities such as a cell-phone, laptop, PC, or any other device with wireless communication capability such as a base-station, router, and the like. The packet may be transmitted either via Wi-Fi or Bluetooth.

A packet is transmitted from master wireless transmitter 640 to system 100. The packet may either be any file such as a photo, music, or the like type of file, from master wireless transmitter 640 or a specific file from a software designed for system 100. The software provides a file for transmission at a predefined frequency of either 980 MHz or 2.4 GHz. The transmission duration of the file, which determines the amount of transferred power, can be selected by the user through the software interface. If an existing file is to be transmitted, its size determines the amount of the transmitted power. Slave device 660 may be a low power device with its own slave battery, such as a receiver phone, which charges by harvesting the energy of the transferred power packet received through system 100. System 100 may or may not have embedded battery 180. The longer the time of the connection, the higher the amount of the power that can be harvested by the slave device. The transmitting and receiving devices should be within a range of 1 meter from each other. After a certain time, the slave device charge reaches a point where it cannot be charged any further by system 100.

In the second mode of operation, the system 100 gathers energy from the electromagnetic signals existing in its surroundings and charges a rechargeable battery 180 embedded in system 100. After rechargeable battery 180 is charged, system 100, including battery 180, is coupled to the slave device, which then can be charged from rechargeable battery 180 in system 100. By storing the energy obtained from these signals in a small rechargeable battery embedded in the system, enough power will always be available for emergency cases where no master device is readily available.

The RF signals existing in the environment can be either from a transmitter designed for system 100 or from the existing GSM, Wi-Fi, or the like signals in the air. As long as the existing signals have a minimum power of −35 dBm, they can be harvested by system 100. This may sometimes give a user the freedom of being as far as 500 (or even more) meters from a GSM base station and still charge rechargeable battery 180 in system 100. The limitation of this mode is that rechargeable battery 180 may not hold much power and may require frequent recharging, which may take extended time for recharging.

Embodiments of the present invention provides a system and method for harvesting radio frequency power from a wireless transmitter. The embodiments of the present invention are not limited by the type of transistor, PMOS, NMOS or otherwise, used to boost the radio frequency power. The embodiments of the present invention are not limited by the number of voltage multiplier stages used to boost the radio frequency power. It will be apparent to those with skill in the art that modifications to the above methods and apparatuses may occur without deviating from the scope of the present invention. Accordingly, the disclosures and descriptions herein are intended to be illustrative, but not limiting, of the scope of the invention, which is set forth in the following claims along with their full scope of equivalents.

What is claimed is:

1. A system for harvesting radio frequency power from a wireless transmitter comprising:
an antenna having an output voltage;
a matching network coupled to the antenna;
a booster circuit coupled to the matching network and having an output voltage, and adapted to amplify the output voltage of the antenna wherein the matching network is adapted to match a power transfer from the antenna to the booster circuit; and
a voltage stabilizer circuit adapted to stabilize the output voltage of the booster circuit.

2. The system of claim 1 further comprising:
a user selectable switch adapted to determine at least one operating mode; and
a connector adapted to charge a slave device wherein the at least one operating mode is adapted to charge the slave device from a master wireless transmitter located within a predetermined distance from the system.

3. The system of claim 1 further comprising:
a user selectable switch adapted to determine at least one operating mode;
a rechargeable battery adapted to be charged by the booster circuit; and
a connector adapted to charge a slave device wherein the at least one operating mode is adapted to charge the rechargeable battery from a wireless transmitter located within a predetermined distance from the system and the rechargeable battery is adapted to charge the slave device.

4. The system of claim 1 wherein the antenna is a wideband antenna.

5. The system of claim 1 wherein the antenna is a wideband circularly polarized micro-strip patch antenna.

6. The system of claim 1 wherein the matching network is a resonant circuit tuned at a predetermined frequency.

7. The system of claim 1 wherein the booster circuit includes a multi-stage voltage multiplier circuit.

8. The system of claim 2 further comprising a software executable on the master wireless transmitter and adapted to provide a user selectable amount of radio frequency power from the master wireless transmitter to the slave device.

9. The system of claim 2 wherein the master wireless transmitter is adapted to transmit a user selectable file wherein the duration of the transmission corresponds to the amount of radio frequency power transmitted from the master wireless transmitter to the slave device.

10. The system of claim 2 wherein the master wireless transmitter is chosen from one of the group of a cell-phone, a laptop, or a personal computer.

11. The system of claim 2 wherein the master wireless transmitter is adapted to transmit radio frequency power chosen from of one of the group of a Bluetooth signal, or a Wi-Fi signal.

12. The system of claim 2 wherein the predetermined distance is about 1 meter.

13. The system of claim 3 wherein the predetermined distance is about 500 meters.

14. The system of claim 3 wherein the wireless transmitter is adapted to transmit radio frequency power for the system.

15. The system of claim 3 wherein the wireless transmitter is adapted to transmit radio frequency power for the system in the form of one of the group of a GSM signal, or a Wi-Fi signal.

16. The system of claim 3 wherein the system is adapted to receive a signal having a power of at least −25 dBm.

17. A method for harvesting radio frequency power from a wireless transmitter by a system including an antenna having an output voltage, a matching network coupled to the antenna, a booster circuit coupled to the matching network and having an output voltage, and a voltage stabilizer circuit, the method comprising;
matching a power transfer from the antenna to the booster circuit;
amplifying the output voltage of the antenna; and
stabilizing the output voltage of the booster circuit.

18. The method of claim 17, wherein the method further comprises determining at least one operating mode.

19. The method of claim 18, wherein the method further comprises charging a slave device from a master wireless transmitter located within a predetermined distance from the system.

20. The method of claim 18, wherein the method further comprises:
charging a rechargeable battery in the system from a wireless transmitter located within a predetermined distance from the system; and
connecting a slave device to the system wherein the slave device is charged from the rechargeable battery in the system.
